(19) United States
(12) Patent Application Publication
(10) Pub. No.: US 2012/0140829 A1
(43) Pub. Date: Jun. 7, 2012

(54) Signal Coding Using Spatial Statistical Dependencies

(76) Inventors: Shantanu Rane, Cambridge, MA (US); Yige Wang, Natick, MA (US); Petros T. Boufounos, Boston, MA (US); Anthony Vetro, Arlington, MA (US)

(21) Appl. No.: 12/960,974

(22) Filed: Dec. 6, 2010

(51) Int. Cl. H04N 7/30

(52) U.S. Cl. 375/240.18; 375/E07.226

(57) ABSTRACT

An encoded signal is decoded based on statistical dependencies between the encoded signal and the side information. A statistical reliability of each transform block of the side information is determined as a function of absolute values of transform coefficients of a transform block. The transform blocks of the side information are grouped into a set of groups based on the statistical reliability of each transform block. The decoding is performed using a statistical dependency between a transform block of the encoded signal and a group including a corresponding transform block of the side information.

### FIELD OF THE INVENTION

The invention relates generally to signal coding, and more particularly to signal encoding and decoding using spatial statistical dependencies between the signal and side information.

### BACKGROUND OF THE INVENTION

Conventional image and video coding, such as coding according to the Moving Picture Experts Group (MPEG) and the International Telecommunication Union (ITU) standards, are well suited for broadcast video and multimedia distribution when there are a larger number of low-complexity receivers (TVs) with decoders, but only a small number of high-complexity transmitters with encoders.

With such video distribution models, computationally demanding motion estimation techniques are employed in the encoder to exploit temporal correlation among video frames. That process of exploiting temporal redundancy before transmission yields excellent compression efficiency, and simplifies the decoding.

FIG. 1 shows a conventional encoder 100 with motion estimation 110. Frames of an input video 101 are processed one block at a time. The motion estimator 110 determines a best matching block of a reference frame stored in a frame memory 111 for a current block to be encoded. This best matching block serves as a prediction of the current block. A corresponding motion vector 112 is entropy encoded 150. A difference 120 between the current block of the input video and the predicted block 121, which is generated by a motion-compensated predictor 130, is obtained. The difference signal then undergoes a transform/quantization process 140 to yield a set of quantized transform coefficients 141. These coefficients are entropy encoded 150 to yield a compressed bitstream 109.

Performing an inverse transform/quantization 160 on the quantized transform coefficients 141 and adding 170 this result to the motion compensated prediction 121 generates the reference frame, which is stored in the frame memory 111 and is used for predicting 130 of subsequent frames of the input video 101. The output bitstream 109 is generated based on the entropy encoding 150 of the motion vector 112 and texture 141 information.

FIG. 2 shows a corresponding conventional decoder 200. An input bitstream 201 is provided to an entropy decoder 210 to yield quantized transform coefficients 211 and corresponding motion vectors 212. The motion vectors are used by a motion compensated predictor 220 to yield a prediction signal 221. The quantized transform coefficients 211 are inverse transform/quantized 230 and added 240 to the prediction signal 221 to yield a reconstructed video 209. Frames of the reconstructed video, which are used for decoding subsequent frames, are stored to a frame memory 250.

The above described coding achieves excellent compression efficiency, but has considerable processing and power costs, which is not a problem in large scale commercial applications, such as film and broadcast studios with nearly unlimited resources. However, there are an increasing number of applications in which the acquisition and encoding of images and video is done with devices that have limited battery and processing power, and limited storage and bandwidth, e.g., cellular telephones, PDAs, environmental sensors, and simple digital cameras with severely limited processing, storage and power resources. Typically, these battery operated devices use simple a microprocessor or microcontrollers. Therefore, there is a need for a low complexity encoder, which can provide good compression efficiency in the encoded signal, and high quality images at a decoder.

FIG. 3 shows such a conventional low complexity encoder 300. An input video 301 is classified 310. The classifier estimates a degree of spatio-temporal correlation for each block in a current frame. Based on a squared error difference between the block to be encoded and the co-located block in a previous encoded frame, a class is determined. For instance, a ‘SKIP’ class indicates that the correlation is very high and the current block does not need to be encoded, while an ‘INTRA’ class indicates that the correlation is very low and the current block is best encoded using a conventional intra-coding scheme. For correlations between these two extremes, a syndrome-based coding scheme is used.

In the next step, a block transform 320, such as a discrete cosine transform (DCT), is applied to decorrelate the data. The transform coefficients are then subject to a zig-zag scan 330 to order the coefficients into a 1D vector of decreasing energy.

A small fraction of the coefficients, which correspond to low-frequency coefficients 331, e.g., approximately 20% of the total coefficients, are subject to a base quantization 340. The quantized coefficients are then input to a syndrome encoder 370 to produce syndrome bits 371. In that particular scheme, a ½-rate trellis code is used for the syndrome coding. A refinement quantization 360 is performed to achieve a target quality for the coefficients that have been syndrome encoded. This operation is a progressive partitioning of the base quantization interval into intervals of size equal to the target quantization step size, where an index 361 of the refinement quantization interval inside the base quantization interval is eventually transmitted to a decoder.

A large fraction of the coefficients, which correspond to higher-frequency coefficients 332, e.g., the remaining 80% of coefficients, are subject to a conventional intra coding, in which the coefficients are subject to conventional quantization 350 and entropy encoding 380 operations as described above.

In addition to the above, a cyclic redundancy check (CRC) of the quantized codeword sequence is calculated by a CRC generator 390 to produce CRC bits 391, which are also sent to the decoder. The CRC bits 391 are used at the decoder to determine the best predictor among several candidate predictors. The CRC bits 391 are combined 399 with the outputs from blocks 360, 370, and 380 to produce the output encoded signal in the form of a bitstream 309.

FIG. 4 shows the corresponding decoder 400. After deinterleaving 410 an encoded input bitstream 401, the decoder performs motion estimation 405, which outputs a predictor 407 including spatially shifted pixels from the frame memory 406. Multiple predictors with different spatial shifts are generated. A syndrome decoder 440 generates a sequence of quantized coefficients based on the received syndrome bits for each predictor. Because the syndrome encoding is based on trellis codes, a Viterbi process is used to identify the sequence of coefficients that is nearest to the candidate predictor. If the decoded coefficients match the CRC by means of the CRC check 445, then the decoding is declared to be successful. Given the decoded syndrome coefficients and the index of the refinement quantization interval sent by the encoder, the inverse base quantization and refinement 420 can be performed to yield a reconstructed set of low-frequency coefficients. The higher-frequency coefficients are decoded through an entropy decoding 450 and inverse quantization operation 460. Both sets of coefficients are then subject to the inverse scan 430 and inverse block transform 470 to yield the decoded video 409. The decoded frames 408 are also stored into frame memory 406 for the decoding of subsequent frames.

There are several disadvantages with the above scheme. First, a majority of the transform coefficients, i.e., the high-frequency coefficients, are encoded using conventional quantization 350 and entropy encoding 380 techniques. Complex scenes contain a substantial amount of high-frequency information. Therefore, the prior art scheme has a considerable amount of overhead and leads to loss of efficiency. Second, the prior art syndrome encoding is based on relatively small 8×8 macroblocks, which decreases an overall rate of compression. Third, the CRC needs to reliably reflect the coefficients. Not only is this an overhead for every block, but also, there is no guarantee that the decoding will be performed correctly.

Distributed Source Coding

Distributed source coding schemes are based on two seminal information theoretic results on correlated sources that are encoded independently but decoded jointly. Distributed source coding method achieves the same asymptotic lossless compression performance as joint encoding of the sources. For example, if the sources are jointly Gaussian distributed, then distributed source coding has the same rate-distortion penalty as joint encoding. Even if the sources are not jointly Gaussian distributed, the rate-distortion penalty with respect to joint encoding is bounded.

As shown in the prior art encoder 500 of FIG. 5, an input video 501 is partitioned, using a switch 510, into two types of frames: key-frames 511 and Wyner-Ziv frames 512. The key frames are regularly spaced frames. These frames are encoded using conventional intra-frame encoding 520, e.g., DCT, quantization and entropy coding, and coded at the target quality level. The Wyner-Ziv frames 512 are subject to a scalar quantization 513 and a turbo encoder 530, which is one form of syndrome coding. The output bitstream 509 is a combination 540 of bits corresponding to both encoded key-frames and Wyner-Ziv frames. It is noted that in that prior art scheme, syndrome bits are generated only for Wyner-Ziv frames, and not for key-frames, and the intra-encoding is conventional, i.e., both low and high frequency coefficients are encoded.

FIG. 6 shows corresponding prior art decoder 600. The input bitstream 601 includes encoded the key-frames and the Wyner-Ziv frames. The encoded key frames are decoded using an intra-frame decoder 610 to yield a reconstructed key-frame 611, while the Wyner-Ziv frames are first subject to a turbo decoder 620 to yield a set of syndrome coefficients, which then undergo a reconstruction process 630 to yield the final reconstructed video 609 using the switch 660. The reconstruction is based on the coefficients output by the turbo decoder, as well as interpolated 640 frame data. The reconstructed Wyner-Ziv and key-frames are stored into a frame memory 650 for the decoding of subsequent frames.

The two main disadvantages of that method are the overhead introduced in sending high-quality key-frames, as well as a delay incurred by sending future key-frames that are required for decoding past frames. In terms of conventional coding schemes, the key frames are I-frames and the Wyner-Ziv frames are analogous to B-frames. As with other conventional coding schemes, a distance between the I-frames indicates the amount of the delay. Assuming that a high delay can be tolerated, placing key frames further apart decreases the amount of overhead. However, doing so also decreases the quality of the interpolation, which, in effect, decreases the overall coding efficiency because more syndrome bits are needed to correct errors produced by the interpolation.

Clearly, it is desirable to have a coding scheme with low encoding complexity, i.e., similar to intra-only coding, but with high coding efficiency, i.e., closer to that of the best inter-frame coding schemes. For example, a distributed video coding method uses a simple encoding scheme to individual frames and exploits inter-frame dependencies only at a decoder. Similarly, a method for distributed coding of multi-band image data instead of employing complex inter-band predictive encoding applies a simple encoding scheme to individual bands of the image data and exploits inter-band dependencies only at a decoder.

The same technique of decoding the encoded signal based on statistically dependent side information applies to distributed compression of other sources including but not limited to video signals, hyperspectral images, multiview images, light field images. Accordingly, there is a need to improve performance of the decoder for decoding the encoded signal using statistically dependent side information.

### SUMMARY OF THE INVENTION

Embodiments of invention are based on a realization that for distributed coding methods, wherein an encoded signal is decoded based on statistical dependency between the encoded signal and side information, that statistical dependency is not uniform and depends on a spatial location of a particular transform block within the encoded signal. The encoded signal can include, but are not limited to video frames, multispectral images, hyperspectral images, or biometric signals.

For example, in multispectral satellite images of the earth, transform coefficients of the transform blocks in regions including sea or clouds are more reliably predictable across all bands of the images than the transform coefficients of the transform blocks regions including scenes of a city.

The embodiments are based on a surprising observation that there is a correlation between the numbers of insignificant transform coefficients in the transform block and the statistical reliability of that block. Specifically, a larger the number of insignificant coefficients indicates that the side information is more reliable. The embodiments use this observation to group the side information into groups.

Accordingly, the embodiments are based on another realization that the statistical dependency of the transform blocks can be indicated by a statistical reliability of each transform block. Moreover, the statistical reliability of each transform block can be determined as a function of absolute values of transform coefficients of the transform block.

Those realizations lead to a surprising result that different transform blocks of the signal in different locations can have the same statistical dependencies, while adjoining transform blocks can have different statistical dependencies. Accordingly, the embodiments of the invention partition the side information into a set of groups of transform blocks based on statistical reliabilities of the blocks and determine the statistical dependencies independently for each group.

For example, in one embodiment, a number of groups in the set of groups is predetermined, and for each group a specific range of values of statistical reliabilities are assigned. A function of absolute values of transform coefficients determines the statistical reliability of the transform block. In some embodiments, this function is the number of transform coefficients in that transform block that have the absolute values less than a threshold and the transform blocks are grouped by comparing the statistical reliability of the transform block with the range of statistical reliabilities specified for groups.

Next, each transform block of the encoded signal is decoded using a statistical dependency between a transform block of the encoded signal and a group of the transform blocks that includes a corresponding transform block of the side information, wherein the statistical dependency is determined independently for each group of transform blocks.

Accordingly, the statistical dependencies are determined for each group of the transform blocks, and are thus more accurate than the statistical dependency determined for the entire side information. Hence, the embodiments of the invention provide coding methods that are more efficient and reliable over the conventional approaches.

Thus, one embodiment discloses a method for decoding an encoded signal based on statistical dependencies between the encoded signal and the side information, comprising the steps of: determining a statistical reliability of each transform block of the side information as a function of absolute values of transform coefficients of a transform block; grouping the transform blocks of the side information into a set of groups based on the statistical reliability of each transform block, such that the statistical reliability of the transform blocks of each group are substantially similar; decoding each transform block of the encoded signal using a statistical dependency between a transform block of the encoded signal and a group including a corresponding transform block of the side information, wherein the statistical dependency is determined independently for each group of the transform blocks of the side information to produce a decode signal. The decoded signal is stored in a memory.

Another embodiment discloses a decoder for decoding a signal from an encoded signal and side information based on statistical dependencies between the signal and the side information, comprising: means for determining a statistical reliability of each transform block of the side information as a function of absolute values of transform coefficients of a transform block; means for grouping the transform blocks of the side information into a set of groups based on the statistical reliability of each transform block, such that the statistical reliability of the transform blocks of each group are substantially similar; and means for determining a statistical dependency for each group in the set of groups.

### DEFINITIONS

In describing embodiments of the invention, the following definitions are applicable throughout (including above).

A “computer” refers to any apparatus that is capable of accepting a structured input, processing the structured input according to prescribed rules, and producing results of the processing as output. Examples of a computer include a computer; a general-purpose computer; a supercomputer; a mainframe; a super mini-computer; a mini-computer; a workstation; a microcomputer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

A “central processing unit (CPU)” or a “processor” refers to a computer or a component of a computer that reads and executes software instructions.

A “memory” or a “computer-readable medium” refers to any storage for storing data accessible by a computer. Examples include a magnetic hard disk; a floppy disk; an optical disk, like a CD-ROM or a DVD; a magnetic tape; a memory chip; and a carrier wave used to carry computer-readable electronic data, such as those used in transmitting and receiving e-mail or in accessing a network, and a computer memory, e.g., random-access memory (RAM).

“Software” refers to prescribed rules to operate a computer. Examples of software include software; code segments; instructions; computer programs; and programmed logic. Software of intelligent systems may be capable of self-learning.

A “module” or a “unit” refers to a basic component in a computer that performs a task or part of a task. It can be implemented by either software or hardware.

### BRIEF DESCRIPTION OF THE DRAWINGS

FIG. 1 is a block diagram of a prior art video encoder using conventional motion estimation and transformation techniques;

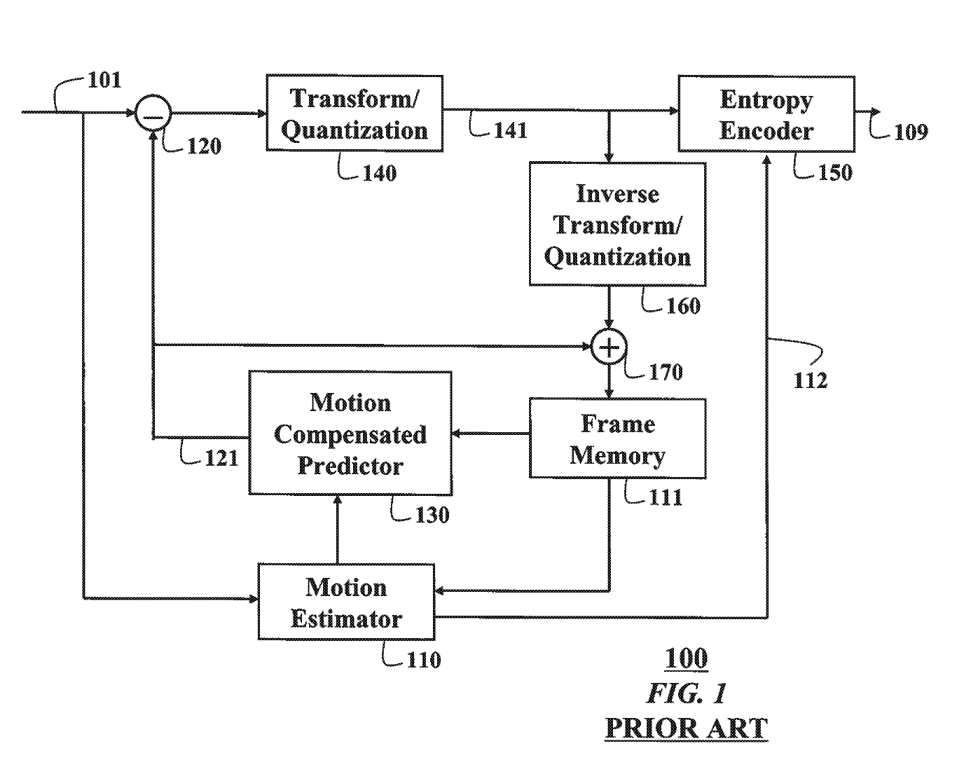

FIG. 2 is a block diagram of a prior art video decoder corresponding to the encoder of FIG. 1:

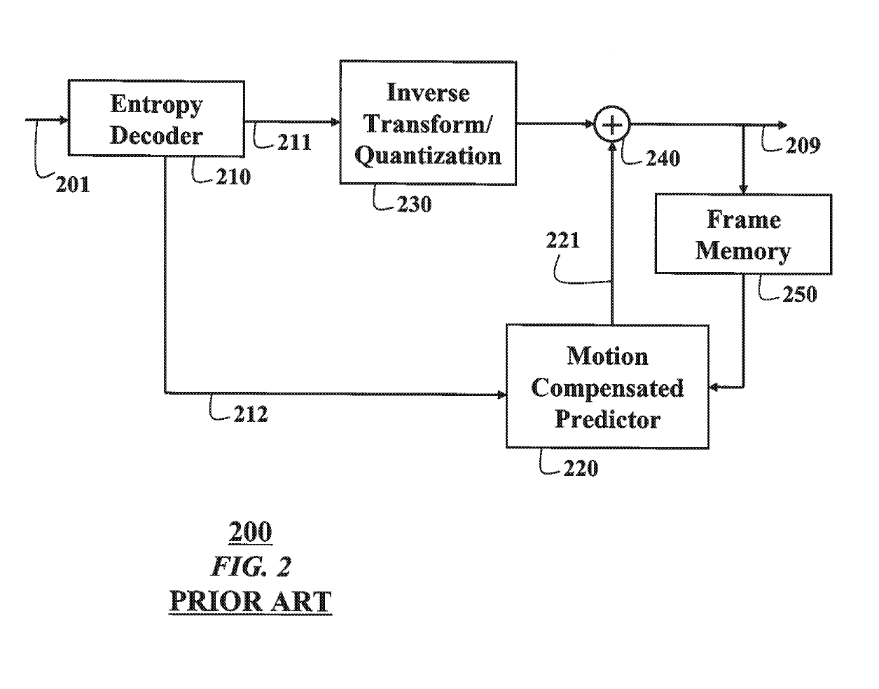

FIG. 3 is a block diagram of a first prior art video encoder using syndrome coding;

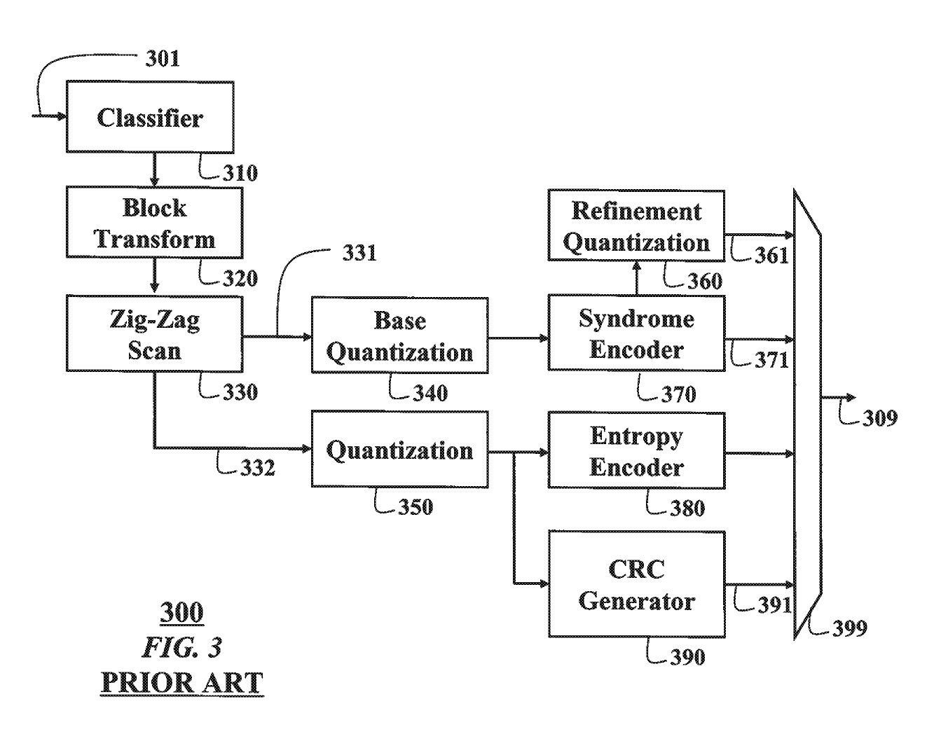

FIG. 4 is a block diagram of a first prior art video decoder corresponding to the encoder of FIG. 3;

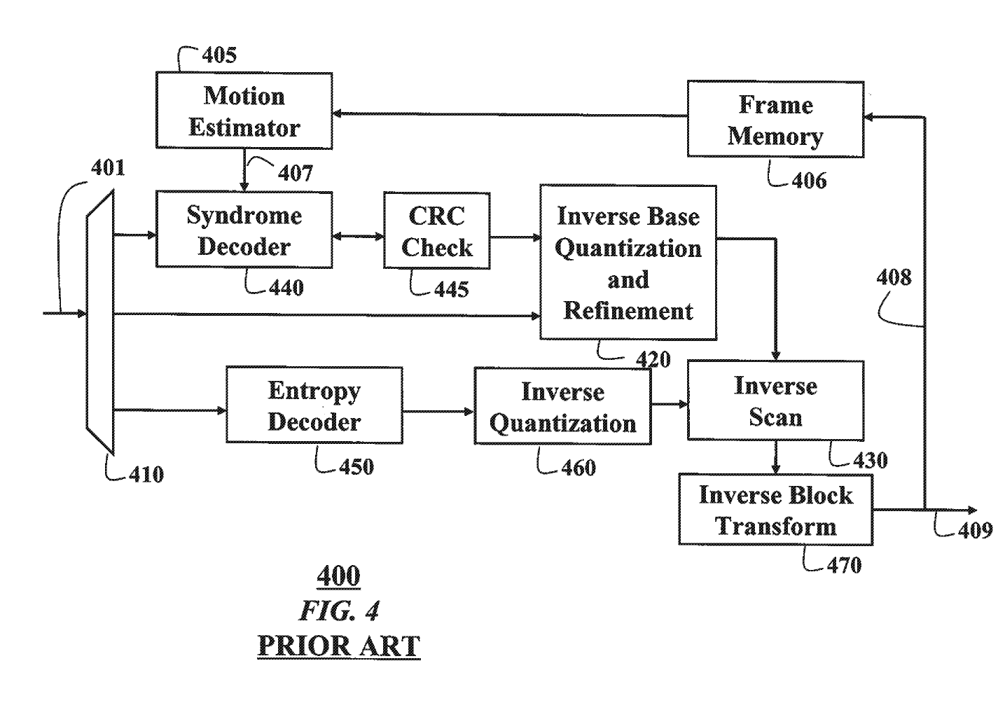

FIG. 5 is a block diagram of a second prior art video encoder using syndrome coding;

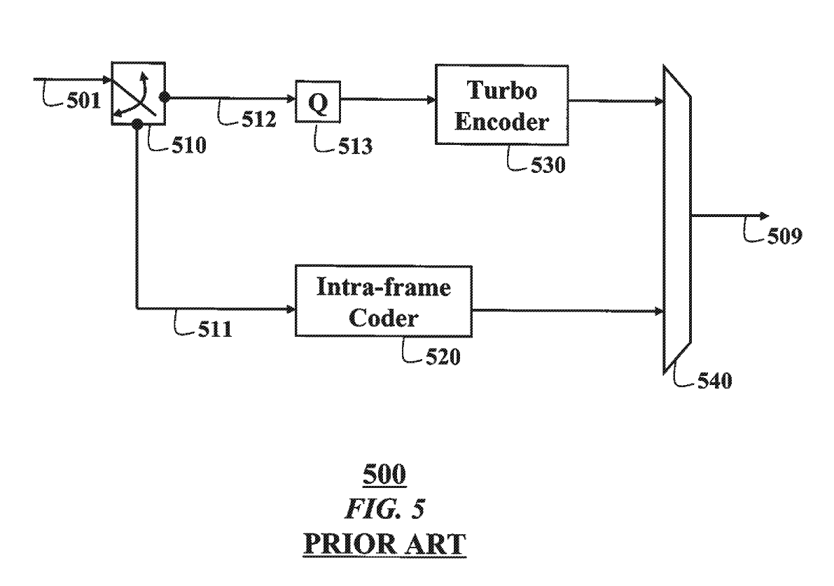

FIG. 6 is a block diagram of a second prior art video decoder corresponding to the video encoder of FIG. 5;

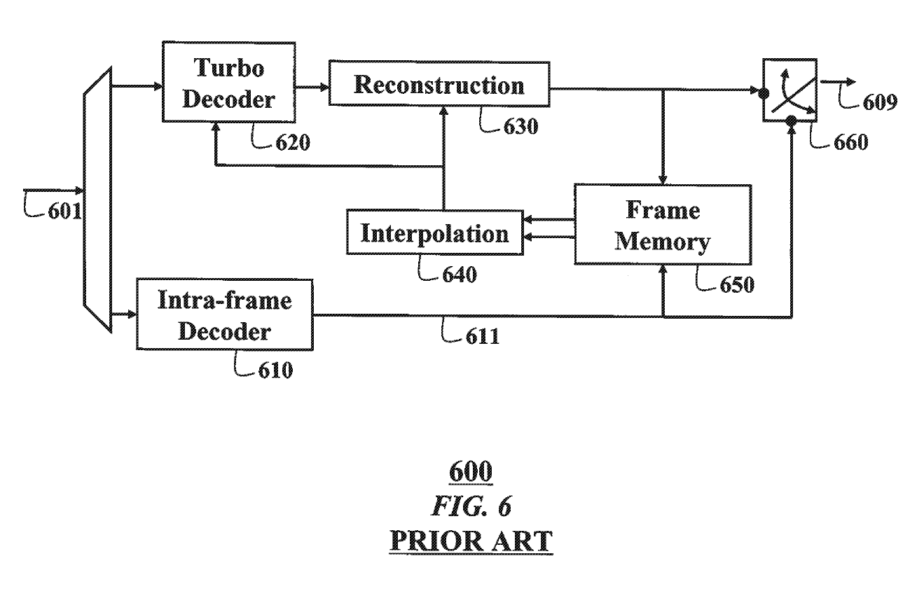

FIG. 7 is a block diagram of a method for grouping transform blocks of side information into a set of groups of transform blocks according to embodiments of the invention;

FIG. 8 is a block diagram of a of a method for decoding the signal from the encoded signal based on spatial statistical dependencies according to embodiments of the invention;

FIG. 9 is a block diagram of an encoder according to one embodiment of the invention; and

FIG. 10 is a block diagram of a decoder according to one embodiment of the invention; and

FIGS. 11A-11B are examples of transform blocks of the side information.

### DETAILED DESCRIPTION OF THE PREFERRED EMBODIMENT

Embodiments of the invention provide a system and a method for decoding n encoded signal based on statistical dependencies between the encoded signal and side information. The encoded signal can include, but is not limited to video frames, multispectral images, hyperspectral images, or biometric signals. If the signal is a video, then the video including a sequence of frames, and each frame is partitioned into blocks.

In various embodiments, the signal is encoded by an encoder as syndrome bits and transmitted to a decoder. The side information can be any information having statistical dependency with the signal, e.g., a key-frame transmitted to the decoder, or a frame previously decoded.

The embodiments of the invention are based on realization that the statistical dependency between the signal and the side information is not uniform and spatially dependent on a location of the transform block in the side information. The transform block is the smallest unit of the encoding/decoding operation. For example, if the signal is a set of images, the transform block can be 8×8 pixels block of an image.

Accordingly, the embodiments group the transform blocks of the side information into a set of groups according to a similarity of statistical reliabilities of the transform blocks. The statistical reliability indicates the reliability with which the transform block in the encoded signal can be predicted from the corresponding transform block in the side information signal. The statistical reliabilities are determined as a function of absolute values of transform coefficients of each transform block. The statistical dependencies are determined independently for each group and are used to decode the encoded signal. The embodiments are implemented using a processor, as known in the art.

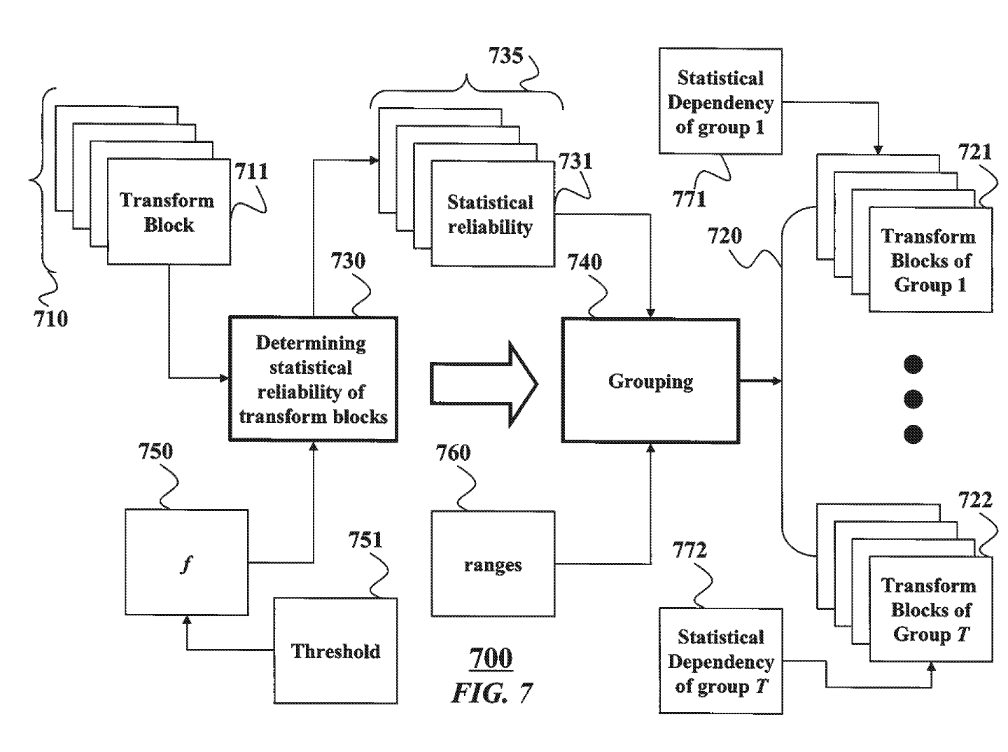

FIG. 7 shows a block diagram of a method 700 for grouping transform blocks 710 of the side information into a set of groups 720 using statistical reliabilities 735 of the transform blocks. The statistical reliability 731 of each transform block, e.g., a transform block 711, is determined 730 as a function 750 of absolute values of transform coefficients of a transform block.

In one embodiment, the function computes a number of transform coefficients having the absolute values less than a threshold 751. In another embodiment, the function computes a number of transform coefficients having the absolute values greater than the threshold. The embodiments are based on a surprising observation that there is a correlation between the numbers of insignificant transform coefficients in the transform block and the statistical reliability of that block. Specifically, the larger the number of insignificant coefficients indicates that the side information is more reliable. The embodiments use this observation to group the side information into groups.

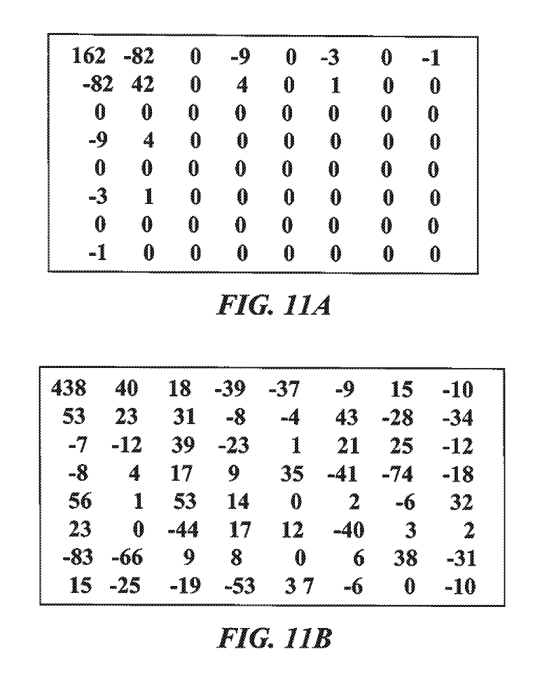

For example, if the threshold is 20, then the transform block shown in FIG. 11A is more reliable than the transform block shown in FIG. 11B. In various embodiments, the threshold is determined empirically based on training data, and on the type of signal being encoded, for example video frames, multispectral images, hyperspectral images, or biometric signals.

Accordingly, the embodiments group 740 the transform blocks of the side information into the set of groups 720 based on the statistical reliability of each transform block, such that the statistical reliability of the transform blocks of each group, e.g., the group 721, are substantially similar. For example, one embodiment determines a number of groups T in the set of groups, and assigns a range 760 of values of statistical reliabilities to each group. The grouping of the transform blocks is achieved by comparing the statistical reliability of the transform block with the range of statistical reliabilities specified for at least one group. Hence, in this embodiment, the substantially similar statistical reliabilities are statistical reliabilities that fall in the same range of values. For example, for T=8, the transform blocks with up to 8 insignificant coefficients are placed in one group, the transform blocks with 9 to 16 insignificant coefficients are placed in a second group, the transform blocks with 17 to 23 insignificant coefficients are placed in a third group, and so on, until 8 groups are formed. The statistical reliability with which the all transform blocks within the group, which can be predicted from the corresponding blocks in the side information, is assumed to be substantially similar.

The statistical dependencies 771-772 are determined independently for each group 721-722, and each transform block of the encoded signal is decoded using the statistical dependency between the transform block of the encoded signal and the group of the transform blocks that includes a corresponding transform block of the side information.

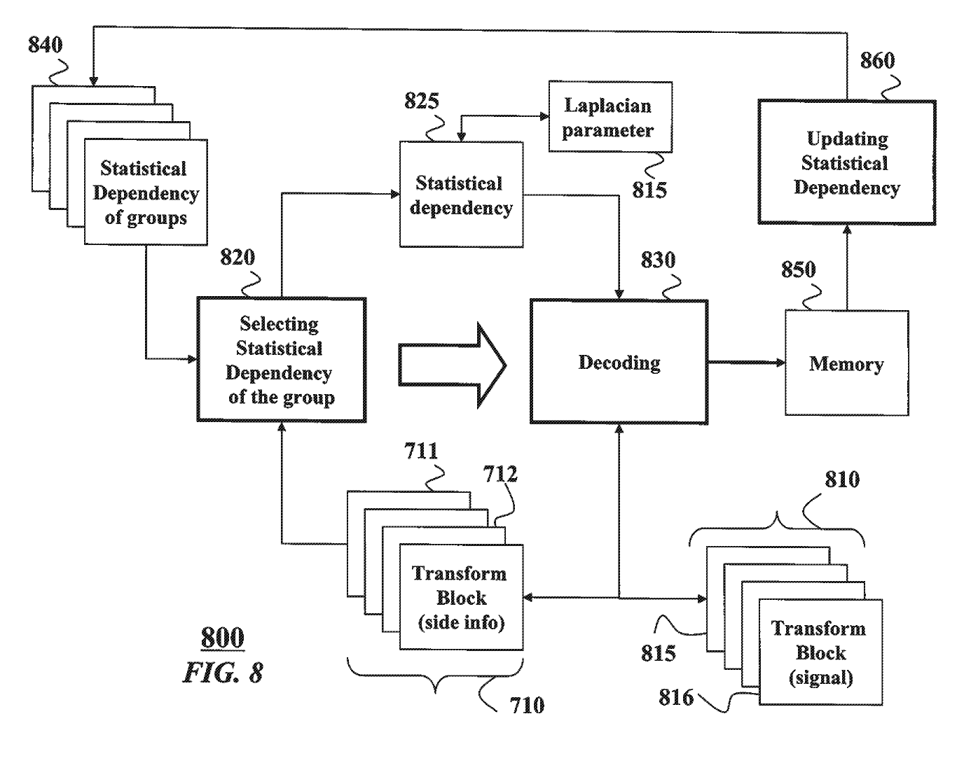

FIG. 8 shows a block diagram of a method for decoding the encoded signal based on the statistical dependencies between the encoded signal and side information. For each transform block 815 of the signal 810, the statistical dependency 825 for a corresponding transform block 711 is selected from a set 840 of statistical dependencies of groups. The statistical dependency 825 is the statistical dependency of a group of the transform blocks that includes the corresponding transform block 711 of the side information.

The statistical dependency is determined independently for each group and is used to decode corresponding transform blocks of the encoded signal. For example, a first statistical dependency 825 of a first transform block 711 is determined while decoding a first portion 815 of the encoded signal, and a second portion of the encoded signal 816 is decoded using a second transform block 712 and the first statistical dependency 825, if the first and the second transform blocks are in the same group.

In one embodiment, the statistical dependency is initialized, e.g., based on the statistical reliabilities of the transform block of the group, and further updated during the decoding. In another embodiment, the statistical dependency is initialized based on a previously decoded signal. In yet another embodiment, the statistical dependency is initialized as a uniform distribution and then updated during the decoding.

For example, in some embodiments, the statistical dependency is the distribution of a difference Δ between the transform coefficients of the transform block of the encoded signal and the transform coefficients of the transform block of the side information. The statistical dependency is modeled based on a zero-mean Laplacian parameter λ, according to

$$f ( Δ ) = \frac{1}{2 λ} {e}^{- \frac{\vert Δ \vert}{λ}} , λ > 0$$

The Laplacian parameter is estimated from the previously decoded transform block that is in the same group. The smaller the value of λ for a transform coefficient, the easier it is to perform interband prediction for that coefficient, and thus the more reliable the side information.

For example, in some embodiments, the decoder decodes every bitplane of every transform coefficient using syndrome decoding. In various embodiments, the decoding 830 depends on the syndrome code used by the encoder. In one embodiment, a low-density parity-check (LDPC) code is used, for which decoding is performed using a belief propagation (BP) method. To initialize BP decoding, the check nodes of the code graph are associated with the received syndrome bits of the encoded signal.

One embodiment denotes the estimate of the number of bits of a transform coefficient by [\hat{b}₁, \hat{b}₂, . . . , \hat{b}_{B}], where \hat{b}_{B} is the most significant bit. Contrary to most prior art distributed source coding, the embodiment decodes from the least significant bit to the most significant bit, i.e., from \hat{b}₁ to \hat{b}_{B}. The rationale is that, when lower significant bitplanes are decoded, the higher bitplanes are easier to decode because candidate values are a greater distance apart. Being a greater distance apart, the decoding of the higher significant bitplanes is more robust.

While decoding the i^{th} bitplane, the initial (log-likelihood ratio) LLR of the j^{th} variable node is determined according to

$${R}_{ij} = ln \frac{Pr [ {\hat{b}}_{i} = 0 \vert {W}_{ij} , {\hat{b}}_{1} , … , {\hat{b}}_{i - 1} ]}{Pr [ {\hat{b}}_{i} = 1 \vert {W}_{ij} , {\hat{b}}_{1} , … , {\hat{b}}_{i - 1} ]} , 1 \leq j \leq L ,$$

where Wᵢⱼ is the value of the transform coefficient of the side information that corresponds to the j^{th} variable node of the syndrome code. The conditional probability for the i^{th} bit is determined based on the Laplacian parameters and from the values of the previously decoded bits of the signal.

Accordingly, in one embodiment, the output of the decoding 830 is stored in a memory 850 and is used to update 860 the statistical dependency of the corresponding group. Various embodiments can independently update the statistical dependencies between the corresponding groups of transform blocks of the signal and the side information, using the already decoded transform blocks of the decoded signal belonging to the corresponding group.

In the state-of-the-art methods, the Laplacian parameter used to derive the LLRs above is the same for all portions of the encoded signal. However, the embodiments of the invention determine, update and reuse the Laplacian parameter according to λₜ, tε{1, 2, . . . , T} where the subscript t indexes one out of T groups. The parameter directly indicates to the BP decoder, how reliable the corresponding transform block of the side information to decode the transform block of the signal. Thus, the performance of BP decoding is improved. In other words, for a given number of syndromes, the embodiments reduce the number of errors in the decoded signal.

Example of Encoder

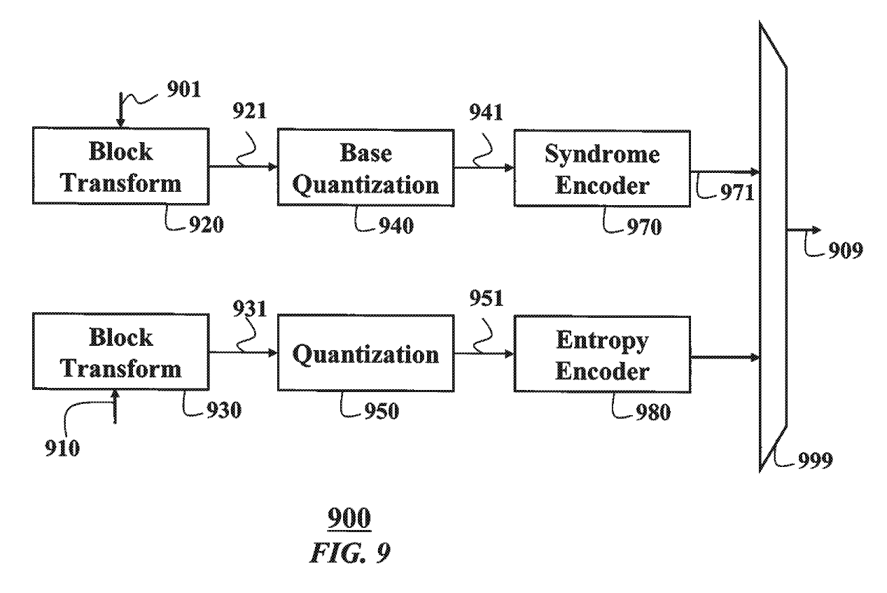

FIG. 9 shows an example of an encoder 900 according one embodiment of the invention. In this embodiment, the encoder is a Wyner-Ziv encoder, which is implemented using a processor as known in the art.

A transform operation is applied to a signal 901 by a block transform module 920 to produce transform coefficients 921. The transform coefficients are quantized by base quantization module 940 using a uniform quantizer with a constant step size for all transform coefficients. In other embodiments, the quantizer is non-uniform, or use a different step size for different transform coefficients.

The quantized transform coefficients 941 are converted by a syndrome encoder module 970 into bitplanes, and a syndrome code is applied by to each bitplane to produce syndrome bits 971. In one embodiment, the syndrome code is a Low-Density Parity Check (LDPC) code. In other embodiments, the syndrome code is any linear channel code, such as Reed-Solomon Code, Bose-Chaudhuri-Hocquenheim (BCH) code, Turbo Code, Raptor Code, Fountain Code, Irregular Repeat Accumulate (IRA) code.

The syndrome encoder module expresses each bitplane extracted from the transform coefficients as a vector, and multiplies this vector by the parity check matrix of the syndrome code. The result of the multiplication is the syndrome bits in a form of a syndrome vector. The length of the syndrome vector depends on the rate of the channel code, e.g., a high-rate code is used for higher significant bitplanes of low-frequency coefficients, resulting in small syndrome vectors.

The syndrome vectors represent the encoded signal transmitted 909 to the decoder as a bit stream. The decoder decodes the signal from the transform coefficients of the side information using the syndrome vectors. The side information can be any information having statistical dependency with the signal, e.g., key-frames 910. In some embodiments the key frames are regularly spaced frames. These frames are encoded at a target quality level. The encoding uses a block transform module 930, a quantization module 950, and an entropy encoder module 980, as know in the art. Typically, the rate of transmission of key-frames is lower that a rate of transmission of the syndrome vectors. The syndrome vectors can be combined 999 with the key-frames for the transmission 909, or be transmitted separately.

### ADDITIONAL INFORMATION

In some applications, the transmitted syndromes are insufficient to decode the signal. Therefore, in one embodiment, LDPC Accumulate (LDPCA) codes are used, such that additional syndrome bits are incrementally generated until decoding succeeds. In those embodiments, the code rate adapts to the difficulty of decoding a specific bitplane. The request to transmit more syndromes is received by the encoder via a feedback channel from the decoder.

In another embodiment, additional helper information is transmitted to the decoder. For example, if the signal is a set of images, each image is partitioned into blocks of the size of the transform blocks, e.g., 8×8 pixels, and average pixel value in each of these blocks is transmitted to the decoder as the helper information. In this embodiment, the side information is mean-shifted at the decoder to utilize the helper information. Specifically, the average pixel value is subtracted from the side information and is substituted with the average pixel values received as the helper information. In another embodiment, a combination of both the average pixel values and the additional syndrome bits are transmitted to the decoder.

Decoder

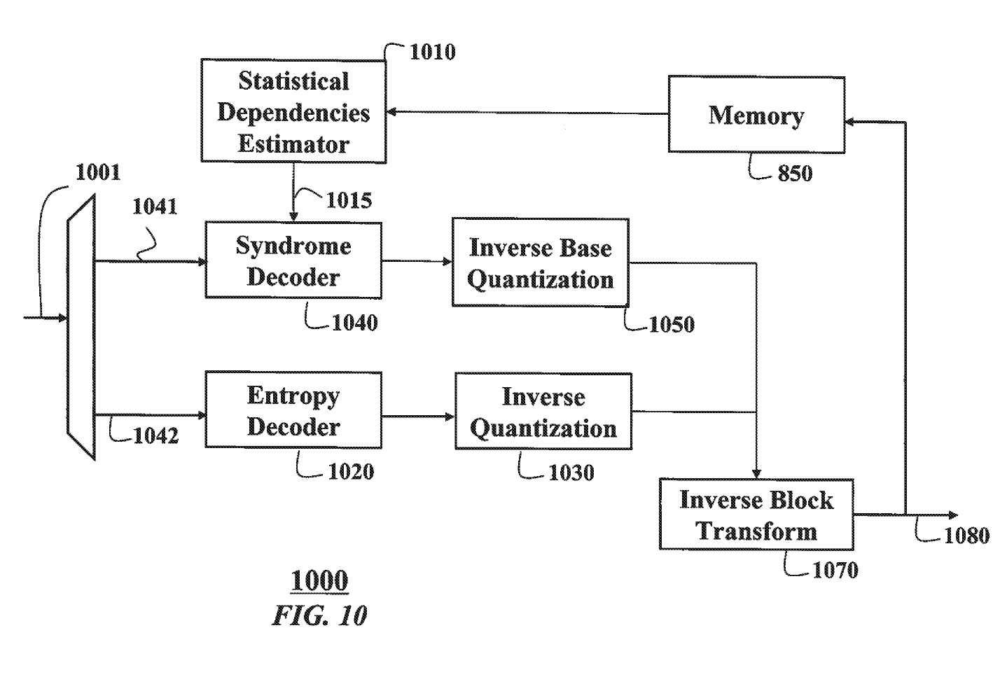

As shown in FIG. 10, the decoder 1000 decodes the encoded signal 1001 based on the syndrome bits of the syndrome vector 1041 and the side information 1042. The decoder decodes every bitplane of every transform coefficient using syndrome decoding 1040. The decoding depends on the syndrome code used. In one embodiment, the LDPCA code is used, for which decoding is performed by BP decoding.

Using iterative BP techniques, LDPC codes are decoded 1040 in time linear to their block length. BP is a message passing process for performing inference on graphical models, such as Bayesian networks and Markov random fields. BP calculates marginal distribution for each unobserved node, conditional on any observed nodes. Belief propagation is commonly used in artificial intelligence and information theory and has demonstrated empirical success in numerous applications including low-density parity-check codes, turbo codes, free energy approximation, and satisfiability.

To initialize the BP decoding, check nodes of a code graph are associated with the received syndrome bits 1041. The marginal distribution for each unobserved node is determined based on the statistical dependencies 1015 of each group determined by a statistical dependencies estimator 1010, as described above. In one embodiment, the side information 1042, e.g., key-frames, is received form the encoder, entropy decoded 1020, inverse quantized 1030 and transformed 1070. The resulted signal is stored in the memory 850 and used for subsequent decoding.

Furthermore, the portions of the signal decoded by the syndrome decoding 1040 are inverse quantized 1050 and transformed 1070 to update the side information in the memory and to form the final decoded signal 1080. In various embodiments, the transform coefficients are decoded bitplane by bitplane and the statistical dependency is updated after the decoding of each bitplane and the updated statistical dependency is used to decode the following bitplanes. For example, in one variation of this embodiment, the update of the statistical dependency includes the update of the log-likelihood ratio of the belief propagation for decoding the bitplane of the encoded signal.

It is to be understood that various other adaptations and modifications can be made within the spirit and scope of the invention. Therefore, it is the object of the appended claims to cover all such variations and modifications as come within the true spirit and scope of the invention.

We claim:

1. A method for decoding an encoded signal based on statistical dependencies between the encoded signal and side information, wherein the statistical dependencies are spatial, the method comprising the steps of:
determining a statistical reliability of each transform block of the side information as a function of absolute values of transform coefficients of a transform block;
grouping the transform blocks of the side information into a set of groups based on the statistical reliability of each transform block, such that the statistical reliability of the transform blocks of each group are substantially similar; and
decoding each transform block of the encoded signal using the statistical dependency between the transform block of the encoded signal and a group including the corresponding transform block of the side information, wherein the statistical dependency is determined independently for each group of the transform blocks of the side information to produce a decoded signal, wherein the steps of the method are performed by a processor.

2. The method of claim 1, wherein the statistical dependency is a Laplacian distribution represented by a Laplacian parameter.

3. The method of claim 1, wherein a parameter of the statistical dependency is unique for each group.

4. The method of claim 1, further comprising:
determining a first statistical dependency of a first transform block while decoding a first portion of the encoded signal; and
decoding a second portion of the encoded signal using a second transform block and the first statistical dependency, if the first and the second transform blocks are in the same group.

5. The method of claim 1, further comprising:
determining, for each transform block of the encoded signal, the corresponding transform block of the side information;
determining the group of the corresponding transform block;
selecting the statistical dependency of the group; and
decoding the transform block of the encoded signal using the corresponding transform block of the side information and the selected statistical dependency.

6. The method of claim 1, further comprising:
updating independently the statistical dependencies between the corresponding groups of transform blocks of the encoded signal and the side information, using the transform blocks of the decoded signal in the corresponding group.

7. The method of claim 1, wherein the function determines a number of transform coefficients having the absolute values less than a threshold.

8. The method of claim 1, wherein the grouping further comprising:
determining a number of groups in the set of groups;
assigning to each group a range of values of statistical reliabilities; and
grouping the transform blocks by comparing the statistical characteristic of the transform block with the range of statistical reliabilities specified for at least one group.

9. The method of claim 1, further comprising
decoding a bitplane of the transform coefficients of the transform blocks of the encoded signal;
updating the statistical dependency after the decoding the bitplane; and
decoding a subsequent bitplane using the updated statistical dependency.

10. The method of claim 9, wherein the updating further comprising:
updating a log-likelihood ratio of a belief propagation method for decoding the subsequent bitplane.

11. A decoder for decoding an encoded signal based on statistical dependencies between the encoded signal and side information, comprising:
means for determining a statistical reliability of each transform block of the side information as a function of absolute values of transform coefficients of a transform block;
means for grouping the transform blocks of the side information into a set of groups based on the statistical reliability of each transform block, such that the statistical reliability of the transform blocks of each group are substantially similar; and
means for determining a statistical dependency for each group in the set of groups to produce a decoded signal.

12. The decoder of claim 11, wherein the statistical dependency is determined independently for each group.

13. The decoder of claim 11, further comprising:
means for selecting the statistical dependency from a set of statistical dependencies based on a group of a transform block of the side information corresponding to a transform block of the encoded signal.

14. The decoder of claim 13, further comprising:
means for determining transform coefficients of the transform block of the encoded signal from transform coefficients of the transform block of the side information based on the statistical dependency.

15. The decoder of claim 14, further comprising:
means for updating the statistical dependency of the group in response to the determining transform coefficients of the transform block.

16. The decoder of claim 11, further comprising:
means for decoding each transform block of the encoded signal using the statistical dependency between a transform block of the encoded signal and a group including a corresponding transform block of the side information, wherein the statistical dependency is determined independently for each group of the transform blocks of the side information; and
a memory for storing the decoded signal.

17. The decoder of claim 11, further comprising:
means for updating independently the statistical dependencies between the corresponding groups of transform blocks of the signal and the side information.

18. The decoder of claim 11, further comprising:
means for comparing the statistical reliability of the transform block with a range of statistical reliabilities specified for a particular group.

19. The decoder of claim 11, wherein the signal is a video including a sequence of frames, and each frame is partitioned into transform blocks.
